(19) United States
(12) Patent Application Publication
(10) Pub. No.: US 2008/0013247 A1
(43) Pub. Date: Jan. 17, 2008

(54) Anti-static pallet

(75) Inventors: Arthur Chang, Taipei (TW); Fu-Ming Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/826,327

(22) Filed: Jul. 13, 2007

(30) Foreign Application Priority Data
Jul. 14, 2006 (TW) 095125946

(51) Int. Cl. H05F 3/00

(52) U.S. Cl. 361/220

(57) ABSTRACT

An anti-static pallet, which is applied to carry objects, includes a main body and a grounding element. The grounding element is disposed in the main body and grounded. The object carried on the main body is able to contact the ground element.

### BACKGROUND OF THE INVENTION

1. Field of Invention

The invention relates to a pallet and, in particular, to an anti-static pallet.

2. Related Art

In step with technological advances, electronic devices are becoming the essential equipments of modem life. Because the electronic devices are usually delicate, they need adequate shielding and protection. For example, electronic devices are usually contained in packages for protection.

Static electricity involves the build-up of charge in objects due to contact between non-conductive surfaces. The electro-static discharge (ESD) is a phenomenon of the motion of the static electricity generated from a non-conductive surface, and the electro-static discharge may damage the circuits of the electronic device.

Referring to FIG. 1, a protecting bag 10, such as a tinfoil bag, is used to accommodate the electronic device and prevent it from being affected by external static electricity, e.g. the static electricity accumulated on the user's hands. Then, the protecting bag 10 accommodating the electronic device is put inside a box 11. The box 11 is then placed on a pallet 12 for convenience of moving and transporting.

However, the electronic devices inside the box 11 may rub against each other to generate the static electricity, which may charge the whole box 11. If the static electricity is not discharged properly, the electronic device may be damaged and thus malfunction.

Therefore, it is an important subject of the invention to provide an anti-static pallet, which can prevent the electronic device from being affected by static electricity.

### SUMMARY OF THE INVENTION

In view of the foregoing, the invention is to provide an anti-static pallet for discharging static electricity.

To achieve the above, an embodiment of the invention discloses an anti-static pallet for carrying an object. The anti-static pallet includes a main body and a grounding element. The main body is used to support the object. The grounding element is disposed in the main body and grounded. When the object is supported by the main body, the object is able to contact the grounding element.

As mentioned above, the anti-static pallet of the invention has a grounding element for grounding the carried object. In the embodiment of the invention, the object may be a container for accommodating a plurality of electronic devices. When the electronic devices rub against each other to generate static electricity, the generated static electricity can be discharged through the grounding element so as to prevent the electronic device from being damaged by the static electricity.

### BRIEF DESCRIPTION OF THE DRAWINGS

The invention will become more fully understood from the detailed description given herein below illustration only, and thus is not limitative of the present invention, and wherein:

FIG. 1 is a schematic view showing a conventional pallet carrying an electronic device for transportation;

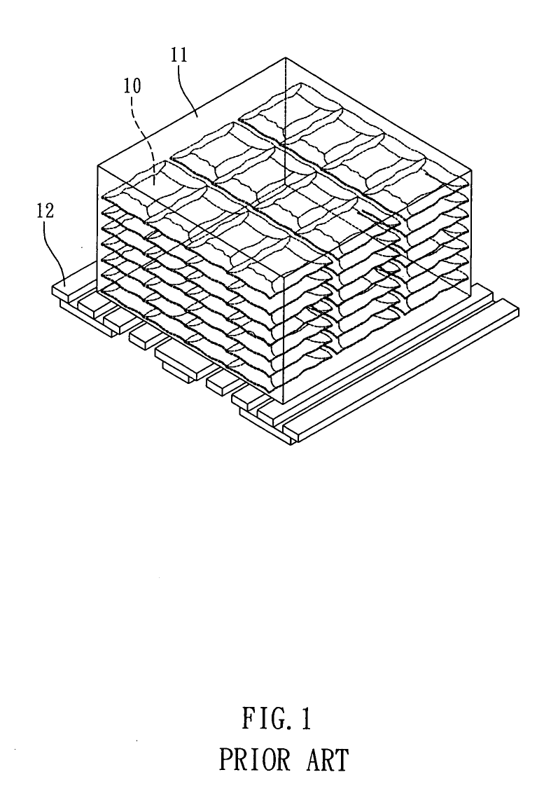

FIG. 2 is a schematic view showing an anti-static pallet according to a preferred embodiment of the invention;

FIG. 3 is a schematic view showing another anti-static pallet according to the embodiment of the invention; and

FIG. 4 is a schematic view showing still another anti-static pallet according to the embodiment of the invention.

### DETAILED DESCRIPTION OF THE INVENTION

The present invention will be apparent from the following detailed description, which proceeds with reference to the accompanying drawings, wherein the same references relate to the same elements.

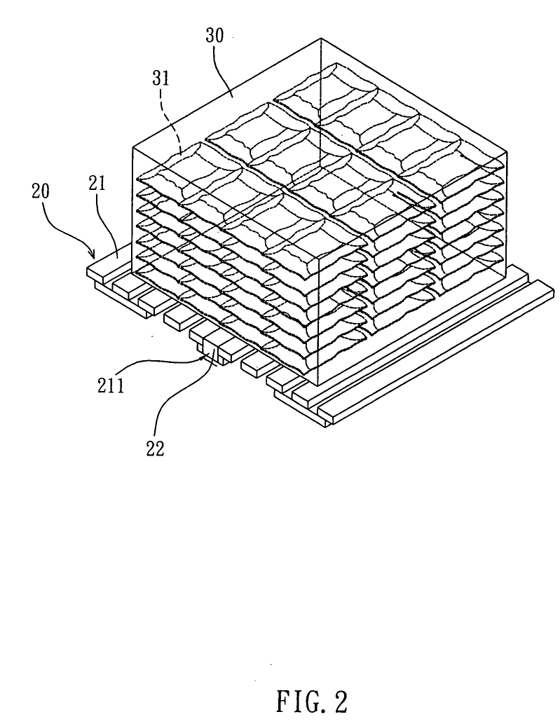

With reference to FIG. 2, an anti-static pallet 20 according to a preferred embodiment of the invention includes a main body 21 and a grounding element 22. In this embodiment, the pallet 20 is used for carrying an object, e.g. a container 30.

In this embodiment, the container 30 accommodates at least one electronic device, which usually includes a circuit board. Moreover, a protecting bag 31 covers the electronic device to prevent the external static electricity, e.g. the static electricity accumulated on user's hands, from damaging the device. Herein, the protecting bag 31 may be made of aluminum foil, copper foil, or polyethylene.

Referring to FIG. 2 again, the container 30 is disposed on the main body 21. In this embodiment, the main body 21 is consisted of a plurality of plates arranged in parallel. The plates are made of wood, and a gap 211 exists between adjacent plates.

As shown in FIG. 2, the grounding element 22 is disposed in the main body 21. In this embodiment, the grounding element 22 is embedded in the main body 21. Furthermore, the grounding element 22 may be disposed in the gap 211 of the main body 21. Accordingly, one side of the grounding element 22 may contact the container 30, and another side thereof may be grounded.

In the embodiment, the grounding element 22 includes an electrically conductive material such as metal or carbon fiber. Alternatively, an electrically conductive coating may be applied to the surface of the grounding element 22 to discharge static electricity.

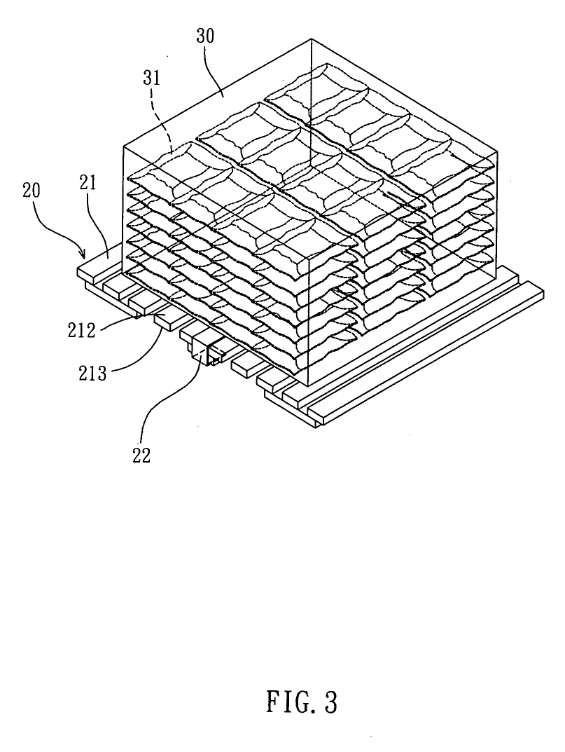

With reference to FIG. 3, the grounding element 22 of the embodiment has a sheet shape and is disposed from a first surface 212 to a second surface 213 of the main body 21. Herein, the first surface 212 is located opposite to the second surface 213. Thus, the grounding element 22 can ground the container 30.

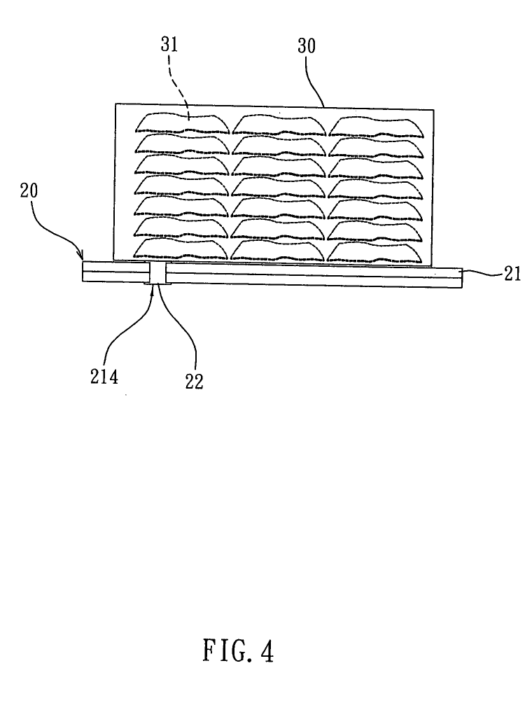

As shown in FIG. 4, the grounding element 22 of the embodiment may be disposed in a through hole 214, which passes through the main body 21 from the first surface 212 to the second surface 213.

In addition, the grounding element 22 of the embodiment may be an elastic structure, such as an elastic sheet, and the number of the grounding element(s) 22 is not limited.

To be noted, the aspects of the grounding element 22 described hereinabove are for examples only, and they are not limited herein.

In summary, the anti-static pallet of the invention has a grounding element for grounding the carried object. In the invention, the object may be a container for accommodating a plurality of electronic devices. Thus, when the electronic devices rub against each other and generate static electricity, the generated static electricity can be discharged through the grounding element so as to prevent the electronic device from being damaged by the static electricity.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An anti-static pallet for carrying an object, comprising:
a main body supporting the object; and
a grounding element disposed in the main body, wherein when the object is supported by the main body, the object is able to contact the grounding element.

2. The anti-static pallet of claim 1, wherein the grounding element is made of metal.

3. The anti-static pallet of claim 1, wherein the grounding element is made of carbon fiber.

4. The anti-static pallet of claim 1, wherein a surface of the grounding element is coated with electrically conductive material.

5. The anti-static pallet of claim 1, wherein the main body consists of a plurality of plates arranged in parallel.

6. The anti-static pallet of claim 1, wherein at least one gap exists in between adjacent two of the plates.

7. The anti-static pallet of claim 6, wherein the grounding element is disposed in the gap.

8. The anti-static pallet of claim 1, wherein the grounding element is embedded in the main body.

9. The anti-static pallet of claim 1, wherein the object is a container for accommodating at least one electronic device.
